(19) United States
(12) Patent Application Publication
(10) Pub. No.: US 2003/0078820 A1
(43) Pub. Date: Apr. 24, 2003

(54) Object based workflow route

(76) Inventor: Norman Ken Ouchi, San Jose, CA (US)

Correspondence Address: NORMAN OUCHI, 20248 VIEWCREST CT, SAN JOSE, CA, 95120, US

(21) Appl. No.: 10/036,200

(22) Filed: Oct. 19, 2001

(51) Int. Cl. G06F 17/60

(52) U.S. Cl. 705/7

(57) ABSTRACT

This invention is related to automation of business or manufacturing processes control and tracking using workflow technology where the process is represented in the form of a route, a step-by-step description of the process. The route is used to control and track a document or manufactured item through a process. In particular, the present invention is related to the representation of the route and the tracking of the document or manufactured item in multiple systems that use the information. In the present invention, a business or manufacturing process is divided into discrete process steps and the sequence of steps is described as a route. A workflow system uses the route to control the document or manufactured item so that the process steps operate on the document or manufactured item in the sequence described in the route. The workflow system can track the state of the document or manufactured item as it progresses through the steps of the route. The workflow system requires a detailed route since it controls the sequence of steps. However, a second workflow system may need an abstracted or object level view of the route. The abstracted view may be used, for example, to track the document or manufactured item for planning purposes. In addition, the abstracted view may be used to create new routes or modify existing routes and the detailed route generated from the abstracted view. The abstraction, or object, is provided by encapsulation of workflow functions into objects where the high level abstracted view of the route is a sequence of objects and the detailed view is the step-by-step workflow operations of the expanded objects.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

This invention is related to automation of business or manufacturing processes control and tracking using workflow technology where the process is represented in the form of a route, a step-by-step description of the process. The route is used to control and track a document or manufactured item through a process. In particular, the present invention is related to the representation of the route and the tracking of the document or manufactured item in multiple systems that use the information.

### BRIEF SUMMARY OF THE INVENTION

In the present invention, a business or manufacturing process is divided into discrete process steps and the sequence of steps is described as a route. A workflow system uses the route to control the document or manufactured item so that the process steps operate on the document or manufactured item in the sequence described in the route. The workflow system can track the state of the document or manufactured item as it progresses through the steps of the route. The workflow system requires a detailed route since it controls the sequence of steps. However, a second workflow system may need an abstracted or object level view of the route. The abstracted view may be used, for example, to track the document or manufactured item for planning purposes. In addition, the abstracted view may be used to create new routes or modify existing routes and the detailed route generated from the abstracted view. The abstraction, or object, is provided by encapsulation of workflow functions into objects where the high level abstracted view of the route is a sequence of objects and the detailed view is the step-by-step workflow operations of the expanded objects.

### BACKGROUND OF THE INVENTION

Workflow concepts and tools permit the planning, controlling, and tracking of the step-by-step execution of a process. Workflow was originally applied to document processing where the processes were well defined and static. Insurance claims processing and loan application processing are examples of processes where workflow has been used in the past. In parallel, workflow technology has been applied to the manufacturing shop floor where the controlling and tracking of manufactured items in a manufacturing line are similar to the controlling and tracking of documents in an insurance claim process. Workflow technology has evolved so that it can be applied to most processes that have process steps that are executed by people or computer controlled equipment. A workflow can be used to implement a process by defining the steps in the process and the sequence of steps. The sequence of steps is called a route. A route can define a process with conditional branching to implement business processes such as an “Approve/Reject” process step or an iterative process that may require loops similar to Do While or For Loop of many programming languages. A route can implement parallel sub-routes including the splitting or “forking” of a route into parallel sub-routes and joining of parallel sub-routes. The fork and join steps may have conditional functions. Parallel computing has a very rich base of knowledge from which the construction of parallel workflow routes may draw. The route structure supports all the basic elements of a Turing machine so the Computer Science of computability may be applied to workflow. The workflow route is similar to a computer program and the workflow engine is similar to a computing engine that executes routes as programs. The key to workflow is the development of the route. Workflow definition can be developed using graphical tools and process modeling tools. Workflow not only is used for the definition of a process but also for the execution and tracking of the process. When a step in a route is completed, the workflow engine determines from the route the next step and sends the work to the person or machine responsible to complete the step. FIG. 1A illustrates a three-step route for a travel expense approval process where the traveler creates the travel expense request in Step 1, the manager approves or rejects the request in Step 2, and if approved, the travel expense request moves to Accounts Payable for payment to the traveler in Step 3. If the expense request is rejected, it is returned to the traveler at Step 1. Since the workflow is executing in real time, each step can be timed and if a step does not complete within a preset time, an alert using e-mail, pager, phone, etc. can be sent to the appropriate people to fix the cause of the delay. The workflow system may be called a shop floor system since it may also control the shop floor equipment used to assemble and test the item in the manufacturing process. The route for a shop floor workflow describes the process steps and the locations at which these processes are executed. These locations are called work centers. The workflow uses the route to direct the manufactured item to be moved from work center to work center and indicates the manufacturing process to be done on the item at each work center. Thus, the route describes the physical movement between work centers and the processes at each work center. To aid in tracking and controlling the manufacturing items, the items may have bar codes or other machine-readable identification. The workflow system may have terminals or computers with displays and bar code readers to instruct the manufacturing operators to execute specific manufacturing process steps and to scan the item with a bar code so that the item can be tracked and to assure that the correct item is processed. The workflow can determine the location and process step for each item and can provide this information to other systems.

The route information is also used by other systems. Specifically, in a manufacturing environment, the Enterprise Resource Planning, ERP, system has a workflow system to control and track the manufacture of items and uses the route to define the manufacturing process for each item to be manufactured. The generation of the route by the ERP system to tailor the manufacturing process is especially applicable for the manufacture of configurable items or the configuration of manufacturing lines that may be used to manufacture a variety of items. The definition of the item is kept in the ERP system and the route to manufacture the item is sent to the shop floor workflow system at the time the item is released to be manufactured. FIG. 1B illustrates a route generated by the ERP system for a item configured for A1 & B1, where the route has the steps to begin the production of the item by bringing all of the necessary parts from the warehouse at the ERP Stage step; to assemble the A1 configuration of the item, which is part of the configuration of the item at ERP Step A1; to assemble configuration B1 of the item, which is the second part of the item configuration at ERP Step B1; to the ERP Test C1 step that tests the production configuration A1 & B1; to step ERP Stock D1 to move the finished item in the stockroom. Most ERP systems have a route creation facility and expect that the route be generated in the ERP system for use by the ERP workflow system. The route used by the shop floor workflow system must carry all of the detail to control and track the item in the manufacturing process. In addition to the steps required for the manufacture of the item, the route must also have steps for the test of the item and the steps required to repair the item should the item fail a test step. The shop floor route controls the movement of the item from shop floor function to shop floor function. These functions are usually called work centers. FIG. 1C illustrates a portion of the shop floor route for the ERP route illustrated in FIG. 1B where each step in the ERP route corresponds to one or more steps in the shop floor route. The repair portions of the route may have the item move from point of the route where the item is more complete to a point in route where the item is less complete so the item can be disassembled, repaired, and retested. The test and repair paths are feedback loops where items can be fed back into the manufacturing process. In FIG. 1C, Stage brings the parts from the warehouse to manufacture the item; Audit checks that all the parts are there; Re-stage corrects error found in the Audit; A1 Set Up configures the equipment for the A1 configuration; A1 Asm assembles the A1 configuration; A1 Test is the testing of configuration A1; if the test is successful, the route continues with the balance of the assembly and test processes; Repair fixes problems found in Test or from other Test steps in the balance of the Route; A1 Retest checks that the repairs correct the problem and is sent to the balance of the route or the item must be re-assembled by sending it to the A1 Asm step. Most shop floor workflow systems have a route creation facility and expect that the route be created using the shop floor system. The ERP system needs to specify the route only in enough detail to define the manufacturing process so that the appropriate manufacturing process is used to manufacture the item. The routes generated using the shop floor workflow system are highly detailed. Both the ERP workflow system and the shop floor workflow system want to control the creation of the route and will generate a route suitable for the purpose of the system. However, in most system configurations, the ERP must be the system that generates the route. But the ERP generated route is not sufficient for use by the shop floor.

The ERP system receives orders for items to be delivered on specific dates and quantities. The ERP system keeps an inventory of all items and schedules the manufacture of items that must be manufactured so that the orders are fulfilled on the requested dates. To assure that the items would be delivered on the requested dates, the ERP system must track the items as they are processed in the manufacturing line. The tracking information is provided by the workflow system. However, the shop floor workflow may have more detail than needed by the ERP workflow system. The added detail adds complexity and computational load to the ERP system.

The route specifies the movement of the item from work center to work center but not the functions within the work center. The function is related to the definition of the work center. If a shop floor physical location can accomplish a variety of functions, the shop floor system needs to define each function as a distinct work center. For flexible shop floors, there would need to be a large number of work centers to represent the different functions of a shop floor location and would need a large number of routes to represent the distinct combinations of the functions. Items that have a high number of configurations may require a route for each configuration. If the routes are generated by hand, the route configuration process may consume measurable resources. It would be desirable if the work centers could be defined by function to minimize the number of work centers and the routes generated by the item configuration to minimize the route generation effort.

In addition, most shop floor workflow do not control the activities within the work center and those systems that do require that the programs be modified, customized, to accommodate the work center functions. These modifications cause the shop floor workflow system to be unique to a particular installation and require unique maintenance and support. It is desirable that the shop floor route also defines the execution of activities within the work center so that the workflow system need not be modified or customized.

In may installations, the ERP and shop floor system operate independent of each other and manual processes transfer information between the two systems. The lack of integration between the ERP and shop floor systems introduces delay, errors, and added manual effort. However, to effect an integration of these two systems, the route must accommodate the requirements of both and permit the ERP workflow and shop floor workflow systems create appropriate levels of the route. It is desirable to define a route usable by the shop floor workflow system and an abstraction of the route for use by the ERP workflow or other system so that the definition at the abstraction level is useable at the shop floor level and tracking at the shop floor level be useable at the abstraction level. In addition, it is desirable that the shop floor workflow controls the functions within the work centers through the definition of the route rather than through modification of the program.

### BRIEF DESCRIPTION OF DRAWINGS

FIG. 1A illustrates a three-step workflow for a travel expense approval process.

FIG. 1B illustrates an ERP workflow route.

FIG. 1C illustrates a segment of a shop floor route that corresponds to a portion of the ERP route illustrated in FIG. 1B.

FIG. 2A illustrates the ERP Stage step and the corresponding object and shop floor route segment.

FIG. 2B illustrates the ERP Step A1 and the corresponding object and shop floor route segment.

FIG. 2C illustrates the ERP Step B1 and the corresponding object and shop floor route segment.

FIG. 2D illustrates the ERP Test C1 and the corresponding object and shop floor route segment.

FIG. 3A illustrates the ERP route where each ERP step has a corresponding object and the connected objects to form the shop floor route.

FIG. 3B illustrates the Libraries and the connection process to form a shop floor route with objects in parallel to the ERP route.

FIG. 4A illustrates a shop floor work center object A1.

FIG. 4B illustrates a second shop floor work center object A1B.

### DESCRIPTION OF THE INVENTION

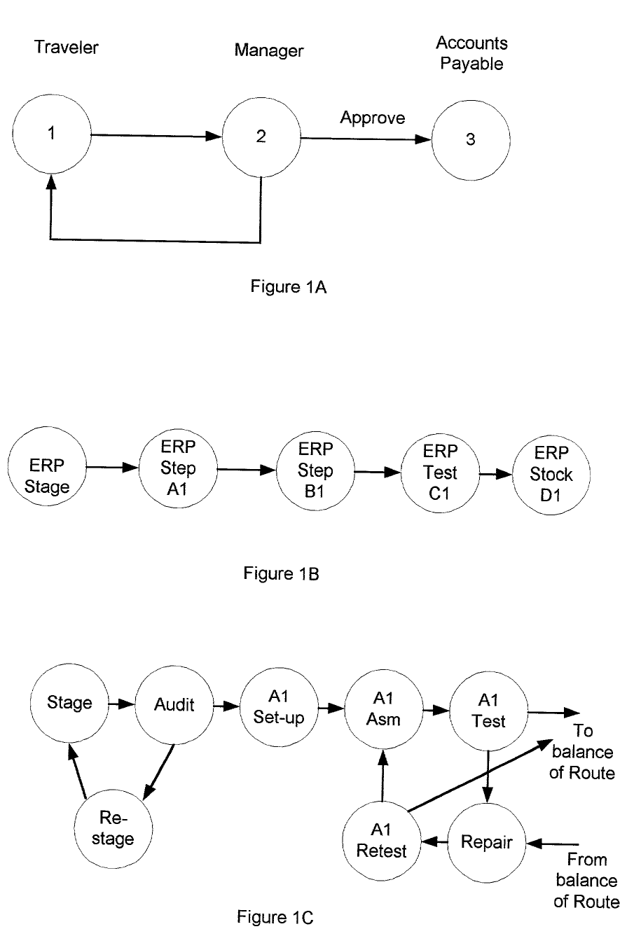

The shop floor workflow route must provide the detailed steps both for the assembly of the item but also for the test and repair processes of the manufacturing process. Many of these detail steps are not needed by the other systems, such as an Enterprise Resource Planning, ERP, system, that use the route in the ERP workflow. However, the route may be created in a system such as the ERP since the ERP system contains the definition of the item to be manufactured, the configuration of the process to manufacture it, and the tracking of the item as it is manufactured. The route must be created at an abstracted level and used at the abstracted level by the ERP system but must be expanded into the detailed route needed by the shop floor workflow system to control and track the item in the actual manufacturing process. There are two workflow systems each with a route where both need to control and track the manufacture of items in a shop floor process. The two routes are tightly interrelated but clearly not the same since the objectives of each workflow system are different. The two routes, one for the ERP system, FIG. 1B, and one for the shop floor workflow, FIG. 1C, can be compared in parallel and the key relationships of the object based workflow route can be observed. In addition, the route can contain the definition of the work center function to provide means so the shop floor workflow system need not be modified when a new function is defined in a work center.

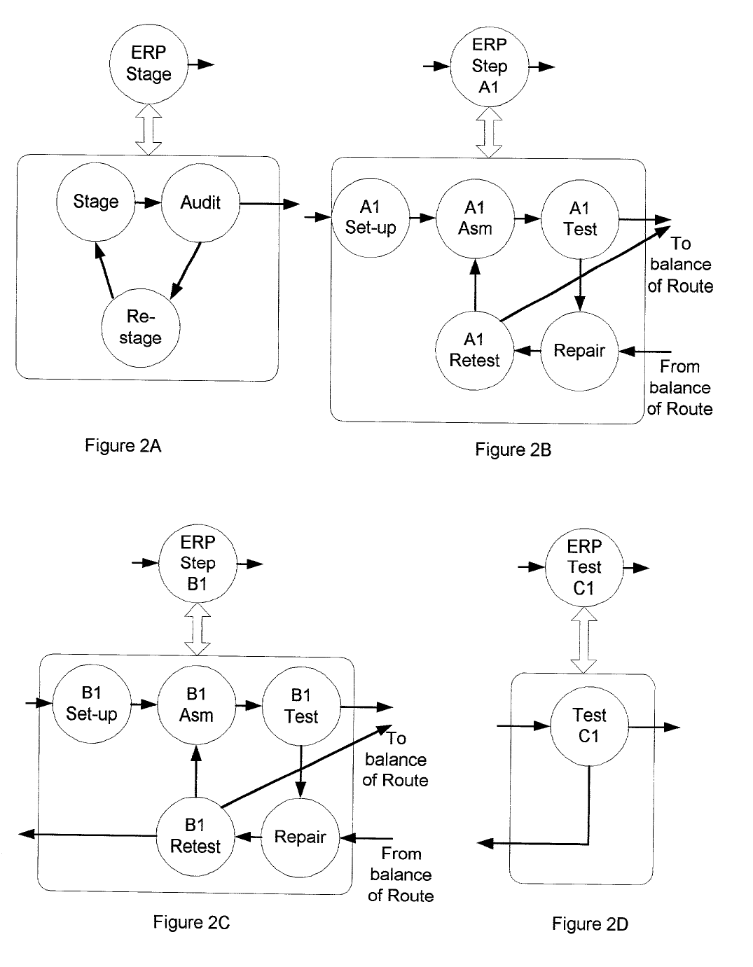

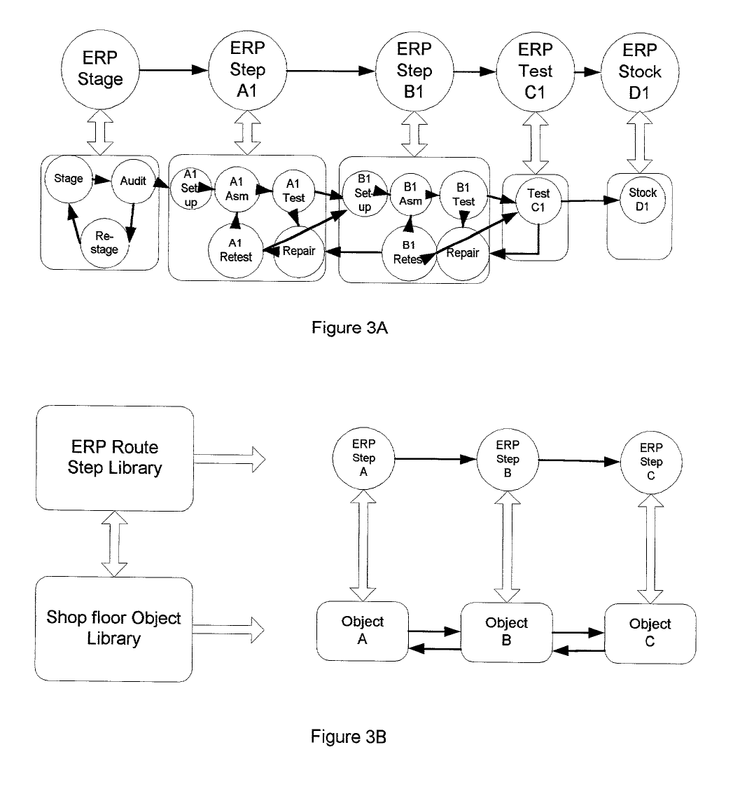

As described earlier, the workflow route and workflow system are like a program and a programming language execution system. Many programming languages provide means for defining a collection of operations as object where the details of the object need not be visible to the developers who use the object in the programs they develop. Thus, the ERP workflow system can create routes by interconnecting ERP level steps that are objects and track the execution of the routes by tracking the execution of objects while the shop floor workflow can execute the detailed step-by-step operations of the expanded objects. Each ERP step is associated with an object that contains a route segment with shop floor workflow steps. FIG. 2A illustrates the shop floor workflow system object associated with the ERP Stage step. The object contains three shop floor workflow steps: Stage, Audit, and Re-stage where the Stage step flows to the Audit step; Audit step is a conditional branch function that can flow to the next object if the audit is successful or if not successful, to the Re-stage step; the Re-stage flows to the Stage step. The external connection to the ERP Stage step is a normal output link that is connected to the input link of the next route segment of the next object when the object is linked into a route. The internal flow within the object has a feedback loop with a conditional branch, the Audit step. FIG. 2B illustrates the object associated with ERP Step A1 step in the ERP workflow system. Within the Step A1 object are five shop floor workflow steps: A1 set-up. A1 Asm. A1 Test, Repair, and A1 Retest. A1 Test and A1 Retest are conditional branch steps where the result of the test or retest determines the flow. If the results of the test or retest are positive, then the item flows to the next object, else, the item is sent to Repair, for test, or to A1 Asm, for assembly. The external connections are an input link for the normal flow, an input link for a repair feedback path, an output link for the normal path and an output link from the Repair step that joins the normal path. FIG. 2C illustrates the object associated with ERP Step B. ERP Step B1 is very similar to the workflow system object ERP Step A1 except the steps are related to assembling configuration Bu. The ERP Step B1 object also has an output link for a feedback path to a repair step in another object. FIG. 2D illustrates the object associated with the ERP Test step. The object is a decision step, Test C1 where a successful test moves the item to the next object and a failure moves the item to a previous step usually Repair. Each ERP route step is associated with an object that is a shop floor workflow route segment where one or more shop floor steps are interconnected with a definition of the input link connections and the output link connections. Connecting the ERP steps connects the shop floor route segments in the objects to form the shop floor workflow route. FIG. 3A illustrates the connected objects including the ERP Stock D1 object that contains the workflow route step Stock D1. Note that the ERP route is a linear sequence of steps while the shop floor workflow route has repair and test feedback loops that reflect the real paths that the item can take when manufactured. The ERP system can track the progress of each item as assembled using the ERP steps objects. The ERP cannot “see” the steps within the objects but the shop floor workflow system can send information to the ERP workflow system so that the ERP system can determine that a specific item is at a ERP step, within an object or the number of items at that object, etc. For the purposes of the ERP, the route is the sequence of steps (that map to objects). For the shop floor workflow system, the route is the detailed network of the connected route segments with steps within the objects. FIG. 3A illustrates the parallel structure of the ERP workflow route and the shop floor workflow route; the correspondence between a step in the ERP workflow route and the object containing a shop floor route segment; and the connection of the shop floor route segments in correspondence with the connection of the steps in the ERP workflow route.

The process for integrating the ERP workflow system and shop floor workflow systems begins with the definition of an object as an encapsulated set of workflow steps in the form of a route segment with input and output connectors and placed in the Shop floor object library. The object is associated with an ERP route step definition in an ERP Route Step library such that when an ERP route is created with that ERP route step, the associated object will be connected into the shop floor workflow route. The ERP system creates the ERP route by selecting and connecting ERP steps from the ERP Route Step Library. The ERP route is passed to an object connecting process that selects for each ERP step the corresponding object from the Shop floor object library and connects the object to generate the interconnected shop floor workflow steps that comprises the corresponding shop floor route. This process is illustrated in FIG. 3B where ERP steps are defined and placed in the ERP Route Step Library. For each ERP step, an object encapsulating a route segment is defined and placed in the Shop floor Object Library and associated to correspond to the step in the ERP Route Step Library. The ERP system is used to create an ERP route by selecting steps from the ERP Route Step Library. The ERP route is illustrated as the connected sequence ERP Step A, ERP Step B, and ERP Step C. The ERP route is passed to a connecting process that selects from the Shop floor Object Library the corresponding object for each ERP step in the ERP route and then connects the objects in the corresponding relationship as the connected ERP steps in the ERP route. The connecting process is illustrated as the selection of objects: Object A corresponding to ERP Step A, Object B corresponding to ERP Step B, and Object C corresponding to ERP step C and the connection of the objects in the corresponding sequence as the ERP route. The shop floor route object connections may have more interconnections than the ERP route.

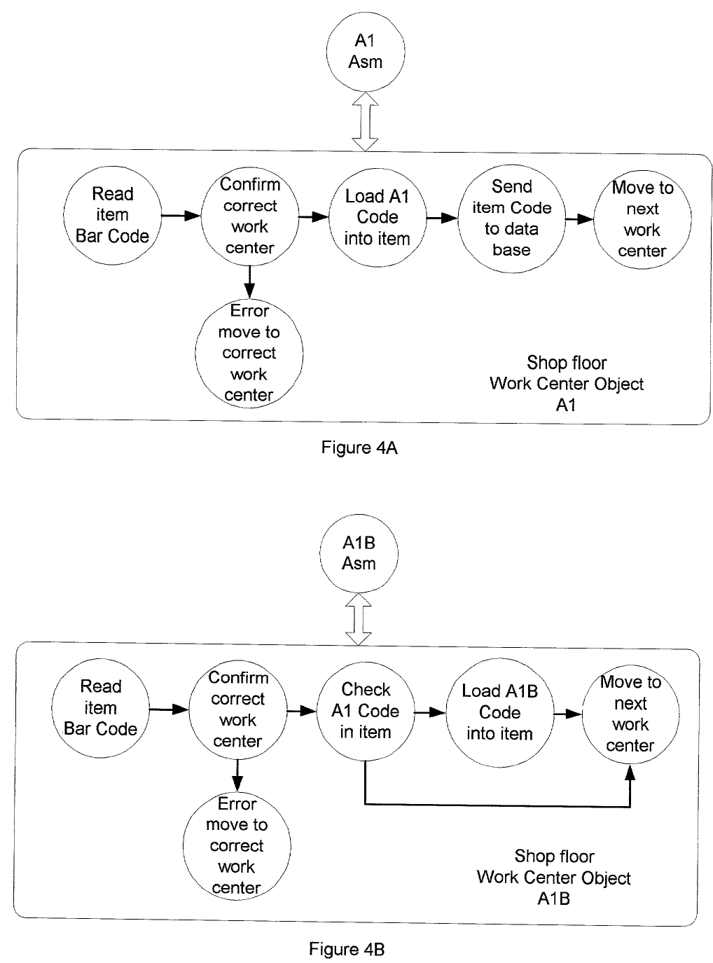

The shop floor work center can also be defined as an object where the shop floor route can be used to define the step-by-step functions within the work center. The work center definition includes the definition of the object corresponding to the work center. The object is an encapsulated route segment where the steps are operations executed within the work center. FIG. 4A illustrates the object corresponding to Shop floor work center Step A1 where the steps are: reading the bar code on the item; checking that the item with the bar code is suppose to be at this work center, if in error, move to the correct work center; load the A1 code into the item; send the item Code to a data base; and move to the next work center. The same physical work center can be configured to execute a different function as illustrated in FIG. 4B where object A1B corresponds to work center Step A1B. Object A1B contains the steps of: reading the bar code of the item; checking that the item with the bar code is suppose to be at this work center, if in error, move to the correct work center; check if A1 code is loaded in the item, if loaded move to the step that moves the item to the next work center, else load A1B code and then move to the step that moves the item to the nest work center. The ability to configure the steps within a work center with the route provides a level of functional tailoring that would normally require modification or customization of the work center program. The shop floor workflow system provides the framework for the execution of objects at work centers rather than just controlling the operations external to the work center.

In addition to controlling the functions and movement of items in the manufacturing process, the shop floor workflow system also can track the location of items and the quantity of items at each work center. If an item has an identifier, for example a unique bar code, it can be tracked and a history of all of the operations on the item can be collected and saved. Some of the tracking information can be passed to the ERP system so that it can schedule and plan the production of the items. The ERP has route where each step is an object in the shop floor route. The shop floor object may have one or more shop floor workflow steps. However, the tracking resolution of the ERP system is to the ERP route step, which is at the object level. The shop floor route segment corresponding to an ERP step may have a shop floor step adapted to report to the ERP system when an item has moved into the object or when an item has moved out of the object. The ERP system can use these reports to relate the number of items in each object or ERP step to track the progress of a set of items in the shop floor manufacturing process. The shop floor step may be further adapted to report the bar code or other identifier to the ERP system so that the ERP system can track the progress of an individual item in the shop floor manufacturing process. In addition, the ERP route may not have feedback paths that allow items to move backwards in the route while the shop floor workflow routes have feedback paths to accommodate repair, re-work, and re-testing. The tracking at the ERP system level must accommodate these differences. The shop floor workflow system can maintain an accurate count of the items in each object as long as items are not fed back in the route. If an item were moved back in the route within an object, the ERP system would not see any difference. If the an item were moved back to another object, the item count for that object could increase without an item input and the previous object would decrease by an item without an output item. The algorithms in the ERP system may not detect these logical inconsistencies. If there are items flowing in the route and the number of items flowing back is small, the count at each object will be accurate. To keep the item count at each step in the ERP system consistent, the tracking function of the shop floor system must maintain the count of items at each object as reported to the ERP system and the actual number of items in the object. When an item moves into the object from a feedback, the actual count and the count in the ERP will differ by one since the item cannot move backwards in the ERP route. However, when an item moves out of the object, the shop floor system will not report the move to the ERP system and the count in the ERP system and the shop floor system will be both correct. If the ERP system will permit a backward move, the shop floor system can just report the reverse move between objects.

The ERP system can have a workflow with a route. The ERP route is a sequence of steps where each step is defined at a level that has significance for the ERP system. The shop floor workflow system has a route. The shop floor route is a sequence of steps where each step is defined at a level that has significance for the shop floor. A step for the ERP system can be associated with an object encapsulating a shop floor route segment. The encapsulated shop floor route segment can have normal input and output links that can be connected to other shop floor route segment and feedback input and output links that can be connected to other shop floor route segments. The sequence of steps in the ERP route can be mapped to a sequence of associated objects and the encapsulated shop floor route segments connected in the same relationship as the steps in the ERP route to form the ship floor workflow route. One form of a connection process starts with the first step of the ERP route; locates the corresponding object; takes the next step of the ERP route, locates the corresponding object, connects the input and output links of the encapsulated route to the input and output links of the encapsulated route of first object; then continues the process of locating and connecting for the next steps in the sequence of ERP steps until all steps in the ERP route are completed. The process creates a shop floor route that has parallel structure to the ERP route where each step in the ERP route has a corresponding object, route segment, in the shop floor route.

The shop floor system can report the progress of items in the shop floor route to the ERP workflow system by reporting the progress of the items in the corresponding route segments.

The sequence of functions in a work center as defined in the shop floor system can be defined and controlled by the shop floor route. The sequence of functions is an object that encapsulates a route for the work center. The shop floor workflow system provides a framework that supports the execution of objects within a work center and accommodates much of the customization and modifications needed to adapt a workflow system to a shop floor.

### DESCRIPTION OF A PREFERRED EMBODIMENT

In U.S. Pat. No. 5,978,836, Ouchi describes the functions of a workflow system with a route and the relational data base tables to implement these functions. The route segments are expressed in a relational data base table using the same structures as the complete route except that the input and output links are not connected. The connector process and work center functions are implemented as software programs written in Java, C++, Microsoft Visual Basic, or a number of programming languages. The programs may use a database for storing, objects, route segments, translation tables and other information. Database programs are available from Oracle, IBM, Microsoft, and many other providers. The ERP system is a program that can be one provided by SAP, Oracle, Baan, or a variety of vendors. These programs and databases execute in computers manufactured by, for example, IBM, Sun, Dell, and Compaq. The computers may be, for example, PC's, workstations, mainframes, and hand-held computers. The computers may have an operating system such as UNIX, LINUX, Microsoft 2000, and IBM OS/9000. The computer is connected to a network that may be, for example, a LAN, WAN, Internet, Intranet, wireless LAN, or wireless Internet.

The ERP Step Library is part of the ERP system and the ERP view of the work centers and functions are defined and stored in the ERP library where each work center—function combination is an ERP step and given a unique name or label that may be selected to be part of an ERP route. The shop floor system has a library where the shop floor view of the work centers and functions are defined and stored and each work center—function is a shop floor step and given a unique name or label that may be selected to be part of a shop floor route or route segment. For each ERP step, a shop floor route segment is created by selecting steps from the shop floor step library to accomplish the ERP function and stored in the Shop floor Object Library with the same name or label as the ERP library name or label. If the names cannot be the same, a relational data base table may be used to cross-reference the names. Each object with a shop floor segment has input and/or output links that serve as the entry and exit points for the route segment. The libraries and mapping functions are designed as tables in a relational database. The route is a relational database structure as described by Ouchi in U.S. Pat. No. 5,978,836.

An ERP route is created by selecting ERP steps from the ERP Step Library and connecting them in a sequence to manufacture the item. This may be a manual process or an automated function of the ERP system. The connector process uses the ERP route as input. For each ERP step, the corresponding object is selected from the Shop floor Object Library. The shop floor route segments are connected in the correspondence with the connection of the ERP steps in the ERP route. The connected shop floor route segments form the shop floor system route corresponding to the ERP route. When the ERP route is instantiated, started, in the ERP system to manufacture items, the corresponding shop floor route is instantiated in the shop floor workflow system to control and track the manufacture of the items. The shop floor steps in each route segment within an object may be adapted to signal to the ERP system when an item has entered or exited the object and the shop floor system can track the number of items in each object and report the count to the ERP system.

A shop floor work center can be defined to provide functions defined in a work center object. The work center program is adapted to respond to work center function process steps provided by the shop floor workflow system over a network that connects the two programs. The shop floor workflow system is provided a library of work center objects where each object is a sequence of work center process steps that can be executed by the work center program. Each object is assigned a unique name or label. The work center object name is included in a shop floor step corresponding to the work center—function where and when in the route the work center functions are to be executed. The work center functions process steps may be implemented as remote calls to dynamic link library functions (DLL's), database remote procedure calls, Corba calls, or other similar programming functions that provide the capability of providing a function from a remote server. The work center program may also be adapted to accept downloaded programs to accomplish the tailored execution of the functions.

I claim:

1. An object based workflow route; a first workflow system with a first route, a connected sequence of steps of a first type; a second workflow system with a second route, a connected sequence of steps of a second type; wherein each step of the first type in the first route has a corresponding object encapsulating a route segment of steps of the second type and the second route is an object based workflow route comprised of a connected sequence of objects corresponding to the connected steps of the first type in the first route and the route segments within the objects connected in correspondence with the connection of the objects.

2. The object based workflow route of claim 1 wherein the first workflow system is an ERP system, the first route is an ERP route, the step of the first type is an ERP step, the second workflow system is a shop floor system, the second route is a shop floor workflow route, and the step of the second type is a shop floor step.

3. The object based workflow route of claim 1 wherein the encapsulated route segment has a feedback input link for connection to another route segment.

4. The object based workflow route of claim 1 wherein the encapsulated route segment has a feedback output link for connection to another route segment.

5. The object based workflow route of claim 1 wherein the encapsulated route segment has a normal input link for connection to another route segment.

6. The object based workflow route of claim 1 wherein the encapsulated route segment has a normal output link for connection to another route segment.

7. The object based workflow route of claim 1 wherein a step of the second type is adapted to report to the first workflow system that an item has moved into the object corresponding to a step of the first type.

8. The object based workflow route of claim 1 wherein a step of the second type is adapted to report to the first workflow system that an item has moved out of the object corresponding to a step of the first type.

9. The object based workflow route of claim 1 wherein a step of the second type is adapted to report to the first workflow system the bar code or other identifier of an item that has moved out of the object corresponding to a step of the first type.

10. The object based workflow route of claim 1 wherein a step of the second type is adapted to report to the first workflow system the bar code or other identifier of an item that has moved into the object corresponding to a step of the first type.

11. The object based workflow route of claim 1 wherein a step of the second type is adapted to report to the first workflow system the quantity of items in the object corresponding to a step of the first type.

12. The object based workflow route of claim 1 wherein a step of the second type is adapted to report to the first workflow system the quantity of items in the object corresponding to a step of the first type by balancing the number of items that enter from feedback input links with items that exit normal output links.

13. A work center object, a work center program and a shop floor workflow system connected by a network wherein the work center program is adapted to accept and execute a function process step from the shop floor workflow system that is adapted to use the route encapsulated in the work center object to provide the sequence of work center function process steps. .

14. The work center object of claim 13 wherein the work center object is associated with a shop floor step.

15. The work center object of claim 13 wherein the work center function can be modified by changing the work center object associated with the work center..

16. A connection process, a first workflow system with a first route, a connected sequence of steps of a first type; a second workflow system with a second route, a connected sequence of steps of a second type;
wherein each step of the first type in the first route has a corresponding object encapsulating a route segment of steps of the second type,
and for each step of the first type in the connected sequence of steps of the first type that form the first route, the connection process connects the associated object to a connected sequence of objects by connecting the input and output links of the encapsulated route segments to form a second route with a connected sequence of objects that is a parallel to the connected sequence of steps of the first type of the first route..

17. The connection process of claim 16 wherein the first workflow system is an ERP system, the first route is an ERP route, the step of the first type is an ERP step, the second workflow system is a shop floor system, the second route is a shop floor workflow route, and the step of the second type is a shop floor step..

18. The connection process of claim 16 wherein the route segment has normal input and output links to connect to other route segments.

19. The connection process of claim 16 wherein the route segment has feedback input and output links to connect to other route segments.

20. The connection process of claim 16 wherein a step of the second type is adapted to report to the first workflow system when an item has moved into the object corresponding to a step of the first type.
